(19) United States
(12) Patent Application Publication
(10) Pub. No.: US 2005/0068888 A1
(43) Pub. Date: Mar. 31, 2005

(54) Seamless balde failover in platform firmware

(76) Inventors: Eshwari P. Komarla, Bangalore (IN); Vincent J. Zimmer, Federal Way, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/672,697

(22) Filed: Sep. 26, 2003

(51) Int. Cl. H04L 12/26

(52) U.S. Cl. 370/216

(57) ABSTRACT

A server platform (SP) having a local node (LN) and a peer node (PN) that responsive to a platform error (PE) at a local node, which is not resolvable at the processor abstraction layer (PAL), determines if there is a PN with an available network interface card (NIC), and if so, the media access control (MAC) address of the LN is sent to the PN so that the PN can handle operations for the LN and the MAC address of the LN is disabled. Error recovery is next performed at either a system abstraction layer (SAL) or by the operating system (OS), and if the PE is resolvable by the SAL or the OS, the LN is enabled with the MAC address of the LN and the LN resumes normal operation. However, if the error is not resolved, then the LN re-boots and resumes normal operation at a later point.

### FIELD

Embodiments of the invention relate to the field of blade based computing systems. More particularly, embodiments of the invention relate to providing seamless blade failover in platform firmware for blade-based computing systems.

### DESCRIPTION OF RELATED ART

Today, computers are routinely used both at work and in the home. Computers advantageously enable such things as file sharing, the creation of electronic documents, the use of application specific software, as well as information gathering and electronic commerce through networks including local area networks (LANs), wide area networks (WANs), business networks, the Internet, etc. In fact, most computers used in business, education, and at home are connected to a network, which enables connection to a server that may provide information or services to the computer.

A server is a network-connected computer system that provides services to network users and manages network resources. Typically, a user operating a computer connects to a server through a network and requests information, services, etc. There are many different types of servers. For example, a file server is a computer and storage device dedicated to storing files that can be accessed by a computer connected through the network to the server. A database server is a computer system that processes database queries from a computer accessing the server through a network. A Web Server is a server that serves content to a Web browser of a requesting computer connected to the Web Server through a network. A Web browser loads a file from a disk and serves it across the network to a requesting computer's Web browser.

Servers increasingly rely on server blades that are designed to slide into the rack of an existing server. A server blade is a single circuit board populated with components such as a processor, memory, and network connections that are usually found on multiple boards. Server blades are cost-efficient, small and consume less power than traditional box-based servers and are interchangeable. Thus, by using server blades, a server is scalable and easily upgradeable.

Server platforms that utilize server blades typically employ methods in standards-based firmware such that, if a server blade fails, an error recovery process is initiated to attempt to resolve the error so that the server blade can once again become functional and again service requests. Unfortunately, when an error occurs that results in a server blade failure, there is often a large latency between the occurrence of the fatal error to the time the server blade becomes fully operational again. This latency may range from a few seconds, to several minutes, to hours. During this time, host requests may be lost or queued up.

Procedures utilized by standards-based firmware in conventional server platforms to correct a platform error typically involve several elaborate error-containment stages utilizing various well known error recovery procedures such as performing a Peripheral Component Interconnect (PCI) bus walk, individually interrogating devices, etc., all of which take a relatively long period of time. Further, if the error is not corrected, and if the operating system (OS) is unable to recover from the platform error, the server blade performs a bug check followed by a dumping of the core and the server blade needs to be rebooted. Unfortunately, this results in a large latency between the occurrence of the fatal error to the time the server blade becomes fully operational again, and during this time host requests may be lost or queued up.

### BRIEF DESCRIPTION OF THE DRAWINGS

FIG. 1 illustrates a server platform including a server blade rack connected to internal and external networks, respectively, in which embodiments of the invention may be practiced.

FIG. 2 is a block diagram showing a simplified example of a node, such as a server blade.

FIG. 3 is a block diagram illustrating a simplified example of a firmware model utilized in embodiments of the present invention.

FIG. 4 is a flow diagram illustrating a seamless blade failover error recovery process in response to a platform error, implemented in the firmware of a server blade of a platform server, according to one embodiment of the invention.

FIG. 5 is a continuation of the flow diagram illustrating the seamless blade failover error recovery process in response to a platform error, implemented in the firmware of a server blade of a platform server, and particularly illustrates the process related to OS error handling processing, according to one embodiment of the invention.

### DETAILED DESCRIPTION

In the following description, the various embodiments of the invention will be described in detail. However, such details are included to facilitate understanding of the invention and to describe exemplary embodiments for employing the invention. Such details should not be used to limit the invention to the particular embodiments described because other variations and embodiments are possible while staying within the scope of the invention. Furthermore, although numerous details are set forth in order to provide a thorough understanding of the embodiments of the invention, it will be apparent to one skilled in the art that these specific details are not required in order to practice the embodiments of the invention. In other instances details such as, well-known methods, types of data, protocols, procedures, components, electrical structures and circuits, are not described in detail, or are shown in block diagram form, in order not to obscure the invention. Furthermore, embodiments of the invention will be described in particular embodiments but may be implemented in hardware, software, firmware, middleware, or a combination thereof.

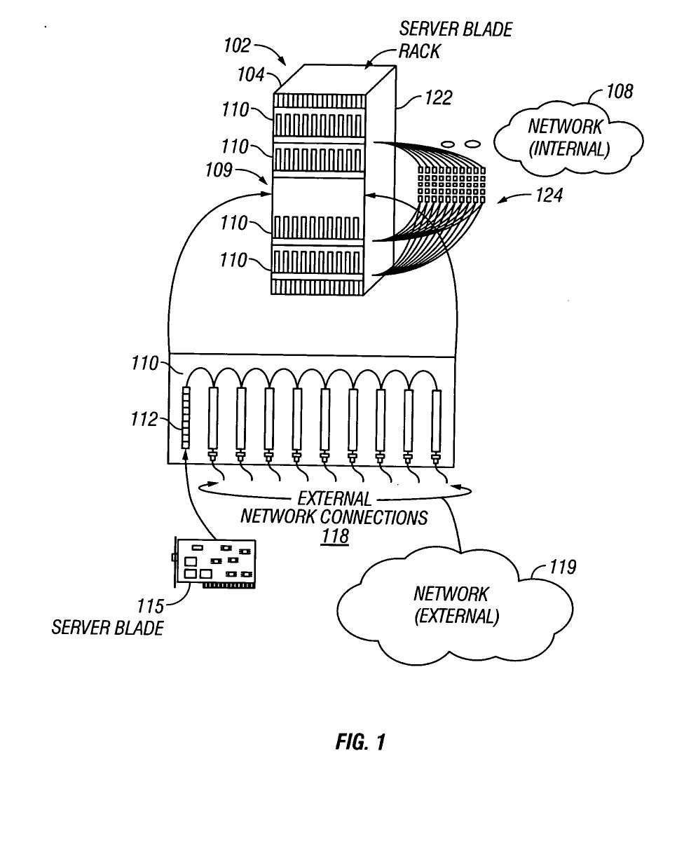

With reference now to FIG. 1, FIG. 1 illustrates a server platform 102 having a server blade rack 104 connected to internal and external networks 108 and 119, respectively, in which embodiments of the invention may be practiced. The server platform 102 may be a network-connected computer system that provides services to network users and manages network resources. Typically, a user operating a computer connects to the server platform 102 through the external network 119 and requests information, services, etc. Server platform 102 may include any type(s) of commonly known servers. For example, the server platform 102 may be a file server, a database server, a Web Server, etc. and/or any combinations thereof.

The internal and external networks 108 and 119 may be any type of network including local area networks (LANs), wide area networks (WANs), business networks, the Internet, etc., and combinations thereof. The networks 108 and 119 may also utilize any type of networking protocol such as transmission control protocol/Internet protocol (TCP/IP), asynchronous transfer mode (ATM), file transfer protocol FTP, point-to-point (PPP) protocol, frame relay (FR) protocol, systems network architecture (SNA) protocol, etc.

As shown in FIG. 1, server platform 102 includes a server blade rack 104 that at the back end 109 includes a plurality of backplanes 110. Each backplane 110 includes a plurality of server blade slots 112 into which a server blade 115 may be inserted and connected. Each server blade 115 provides an external network connection 118 to the external network 119. Also as shown in FIG. 1, the server blade rack 104 includes a front end 122 to which other network connections 124 to internal network 108 may be made.

Each server blade 115 is designed to slide into the server blade rack 104 of the server platform 102. Each server blade 115 is a single circuit board populated with components such as a processor, memory, and network connections. Server blades 115 are designed to be interchangeable with one another. By using server blades, a server is scalable and easily upgradeable. Particularly, the server blades 115 provide architecturally defined flows in firmware to process errors.

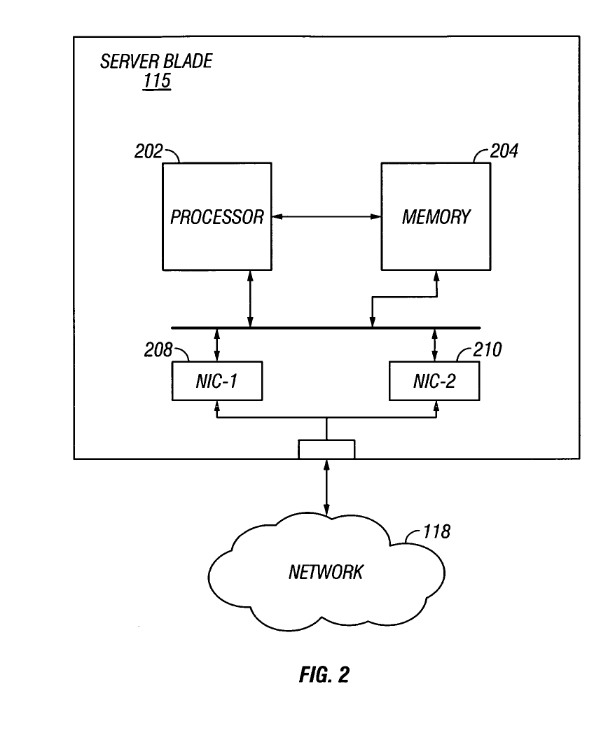

Turning briefly to FIG. 2, FIG. 2 is a block diagram showing a simplified example of a node, such as a server blade 115. In its most basic form, a server blade 115 includes a processor 202 to control operations, coupled to a memory 204, both of which are coupled to a first and second network interface cards (NIC-1 and NIC-2) 208 and 210, respectively. Both NICs are capable of interfacing the server blade 115 of the server platform 102 to a network 118 and to control incoming and outgoing data traffic between the server blade 115 and the network 118. Typically, one of the NICs is active and the other NIC is a back-up for use in case of error recovery, as will be discussed.

The server blade 115, as part a server platform, may utilize standards-based firmware under the control of processor 202 and utilizing memory 204. Particularly, each server blade 115 of the server platform 102 may implement architecturally defined flows in a firmware stack to process errors, as will be discussed, including embodiments of the invention related to a seamless blade failover recovery process.

Also, in one embodiment, the server platform may be an ITANIUM® based server platform that utilizes ITANIUM® server blades, which provide architecturally defined flows in an ITANIUM firmware stack to process errors. ITANIUM® is a registered trademark of the Intel® Corporation.

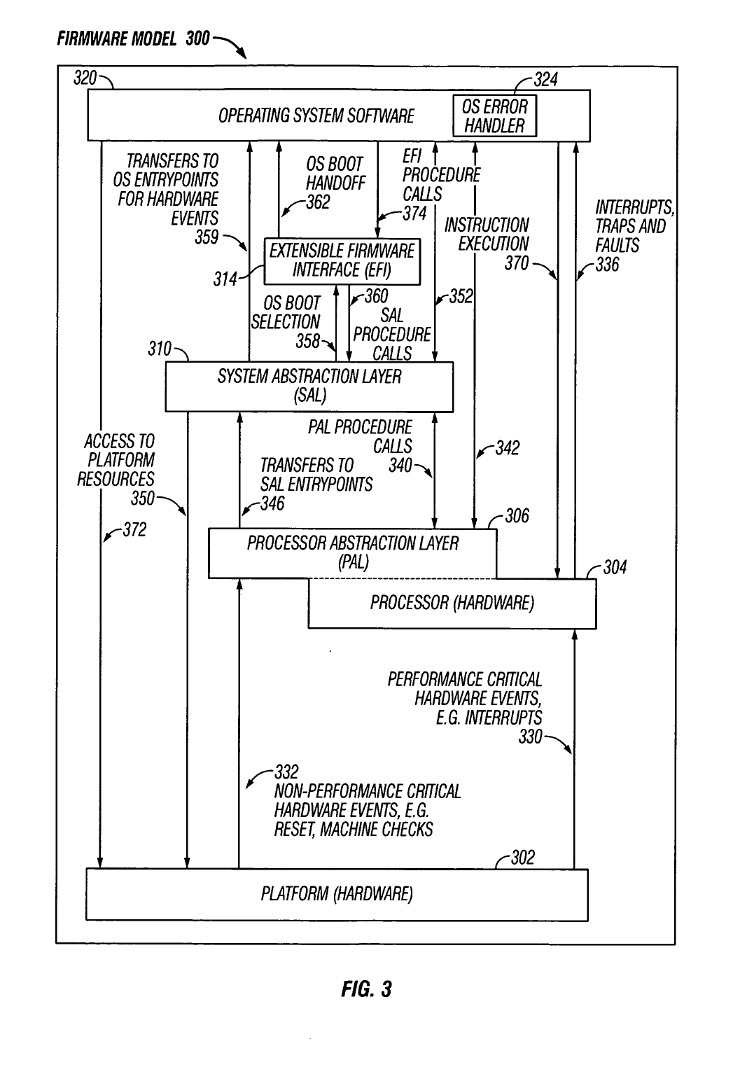

With reference now to FIG. 3, FIG. 3 is a block diagram illustrating a simplified example of a firmware model 300 for use by a server blade 115 of the server platform 102, utilized in embodiments of the present invention. As can be seen in FIG. 3, the firmware model 300 includes platform hardware 302, processor 304, a processor abstraction layer (PAL) 306, a system abstraction layer (SAL) 310, and an extensible firmware interface (EFI) 314, and operating system (OS) software 320 having an OS error handler 324 to implement error handling techniques at the OS level, including embodiments of the invention related to seamless blade failover recovery, as will be discussed.

The firmware model 300 enables the boot-up of a server blade. The firmware 300 ensures that firmware interfaces encapsulate the platform implementation differences within the hardware abstraction layers and device driver layers of operating systems and separate the platform abstraction from the processor abstraction. The firmware 300 supports the scaling of systems from low-end to high-end including servers, workstations, mainframes, supercomputers, etc. Further, the firmware 300 supports error logging and recovery, memory support, multiprocessing, and a broad range of I/O hierarchies.

Particularly, PAL 306 encapsulates the processor implementation-specific features for the server blade 115. SAL 310 is a platform-specific firmware component that isolates operating systems and other higher-level software from implementation differences in the server blade 115. EFI 314 provides a legacy-free application program interface (API) to the OS 320. PAL 306, SAL 310, and EFI 314 in combination provide for system initialization and boots, error handling, platform managed interrupt (PMD handling, and other processor and system functions that may vary between implementations of the server blade 115.

As can be seen in FIG. 3, the platform hardware 302 communicates with the processor 304 regarding performance critical hardware events (e.g. interrupts) (arrow 330) and with PAL 306 regarding nonperformance critical hardware events (e.g. reset, machine checks) (arrow 332).

Processor 304 communicates with OS 320 regarding interrupts, traps and faults (arrow 336). PAL 306 is communicatively coupled with SAL 310 (arrow 340) and OS 320 (arrow 342) regarding PAL procedure calls and communicates with SAL regarding transfers to SAL entry points (arrow 346).

SAL 310 communicates with the platform hardware 302 regarding access to platform resources (arrow 350). SAL 310 is communicatively coupled with OS 320 (arrow 352) in relation to SAL procedure calls. SAL 310 communicates with EFI 314 regarding OS boots selection (arrow 358). SAL 310 communicates with OS 320 regarding transfers to OS entry points for hardware events (arrow 359). EFI 314 communicates with SAL 310 regarding SAL procedure calls (arrow 360) and OS 320 regarding OS boots handoff (arrow 362).

OS 320 communicates with processor 304 regarding instruction execution (arrow 370) and to platform hardware 302 (arrow 372) regarding access to platform resources. Also, OS 320 communicates with EFI 314 regarding EFI procedure calls 374.

As will be discussed, the firmware 300 utilizes a seamless blade failover error recovery process in order to reduce latency times when performing error recovery. This seamless blade failover error recovery process is basically effectuated through a combination of an out-of-band (OOB) channel and exchanging network interface card addresses between server blades.

Embodiments of the invention relate to a local node (i.e. a local server blade) of a server platform that, responsive to a platform error at the local node, performs error recovery at a processor abstraction layer (PAL). If the platform error is not resolved at the PAL, it is determined if there is a peer node (i.e. a peer server blade) with an available network interface card (NIC), and if so, the media access control (MAC) address of the local node is sent to the peer node so that the peer node can handle operations for the local node. Further, the MAC address of the local node is disabled. Error recovery is next performed at the system abstraction layer (SAL), and if the platform error is resolved by the SAL, the local node is enabled with the MAC address of the local node and the local node resumes normal operation. If the SAL does not resolve the platform error, then error recovery is performed at the operating system (OS) level, and if the platform error is resolved at the OS level, the local node is enabled with the MAC address of the local node and the local node resumes normal operation.

Particularly, the firmware 300 of each server blade 115 implements a seamless blade failover error recovery process in response to platform errors such as errors related to chipsets, devices, memory, I/O buses, etc. In one example, platform errors may result in a machine check abort (MCA) error. As will be discussed below, a seamless blade failover error recovery process at the PAL level, at the SAL level, and at the OS level is utilized to attempt to correct the error while simultaneously enabling another peer server blade to continue processing requests for the error affected server blade. Embodiments of the invention generally relate to taking the error affected server blade off-line in firmware, while passing its network ID to a peer server blade, such that the latency of error containment may be drastically reduced or eliminated.

More particularly, the firmware 300 includes architecturally-defined flows, wherein the firmware 300 upon receipt of a platform error (e.g. a machine check abort (MCA) error) at the PAL 306 level and the SAL 310 level, try to correct the error. However, if the error is not correctable at these levels, the firmware 300 hand-shakes with the operating system software 320 in order to let the OS attempt error recovery. Further, the firmware 300 can “blank” or disable the node and convey its network ID, via its media access control (MAC) address to a peer node; later, the former node can “unblank” and again come on-line during a latter control point when the operating system software 320 has retrieved the error information and the node is again functional.

Thus, another peer node can take over the network ID and traffic associated with a node that is engaged in error-containment to thereby reduce latency times associated with waiting for the node to recover and then trying to recover lost traffic or queued up jobs. In this way, the firmware 300 can seamlessly pass the network ID of the node engaged in error-containment to a peer node. It should be noted that the term node generally refers to an entity, such as a server blade having a NIC that performs server-type functions. It should be noted that in, one embodiment, each server blade may have at least one back-up NIC (see FIG. 2), such that the peer node can utilize the back-up NIC to take over network traffic for the node engaged in error containment, while continuing to process network traffic using its own original NIC.

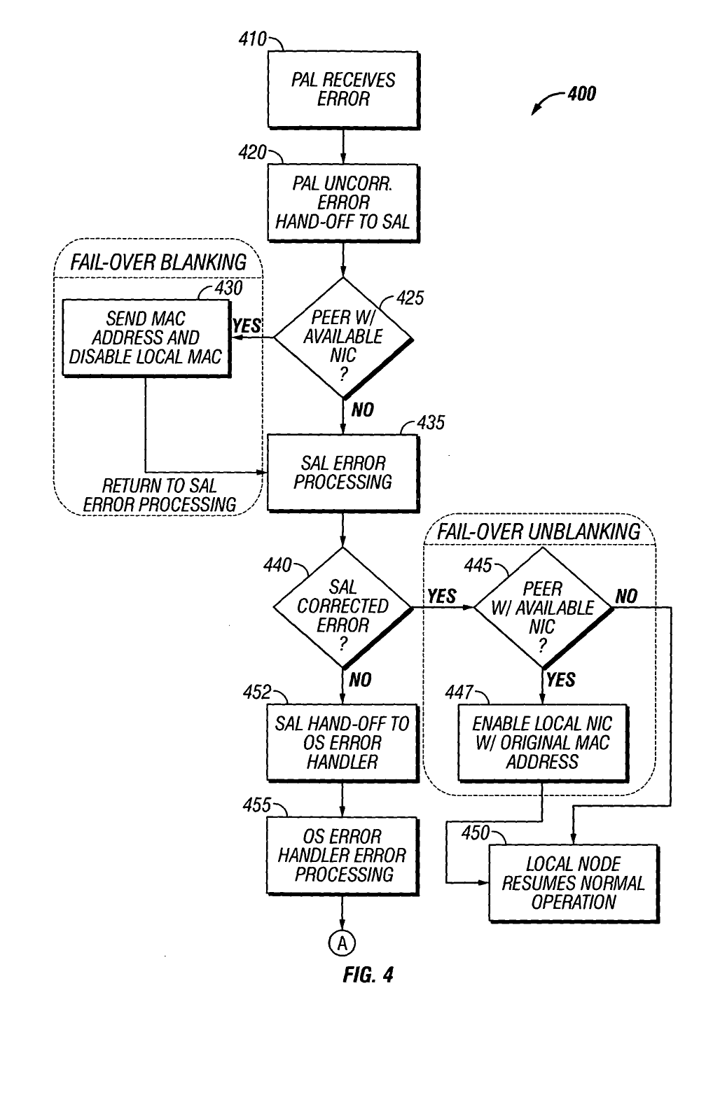

Turning now to FIG. 4, FIG. 4 is a flow diagram illustrating a seamless blade failover error recovery process 400 in response to a platform error, implemented in the firmware of a server blade of a platform server, according to one embodiment of the invention. At block 410, the processor abstraction layer (PAL) receives a platform error. As previously discussed, platform errors are typically errors related to platform components such as processor errors, chipset errors, memory errors, I/O device errors, etc. In one embodiment, a platform error results in a machine check abort (MCA) error. It is assumed at block 420 that the PAL level of the firmware is unable to correct the platform error and that the PAL hands-off the error to the system abstraction layer (SAL).

The process 400 then determines whether there is another peer node (i.e. peer server blade) with an available NIC (block 425). If so, a failover blanking procedure is initiated wherein the MAC address of the node engaged in error-containment is sent to an available peer node with an available NIC and the local MAC of the local node (i.e. local server blade) engaged in error-containment is disabled (block 430). The process 400 then returns to SAL error processing (block 435).

At block 440, it is determined whether the SAL level error processing corrected the error. For example, memory failures in random access memory (RAM) are a type of error that that SAL level error processing can readily resolve. If so, a failover unblanking procedure is initiated. It is next determined whether there was a peer node with an available NIC, which took over operations during the prior failover blanking procedure (block 445). If so, then the local node (i.e. local server blade) having the local NIC with the original MAC address is re-enabled (block 447) and resumes normal operations (block 450).

However, if there was not a peer node with an available NIC that took over operations during the prior failover blanking procedure, but SAL nonetheless corrected the error without a peer node taking over in the meantime, the local node (i.e. local server blade) is just re-enabled and resumes normal operations (block 450).

On the other hand, if at block 440, it is determined that the SAL level error processing did not correct the error, then the SAL hands-off the error recovery operations to the OS error handler of the operating system (block 452). At block 455, the OS error handler of the OS engages in error processing.

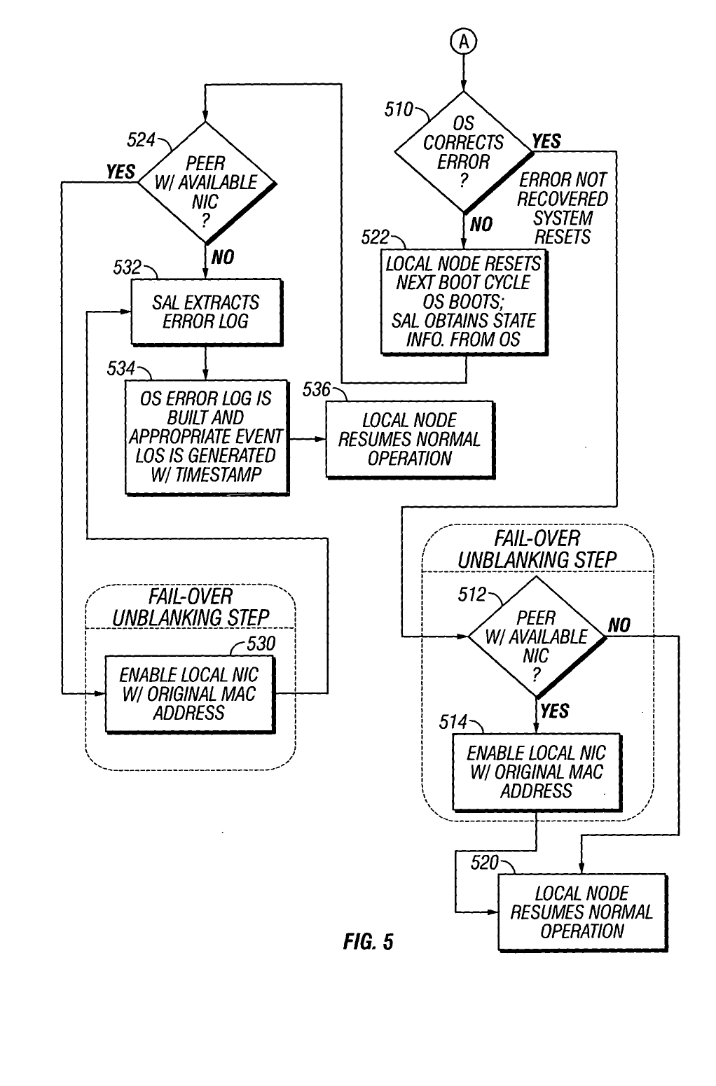

With reference now to FIG. 5, FIG. 5 is a continuation of the flow diagram illustrating the seamless blade failover error recovery process in response to a platform error, implemented in the firmware of a server blade of a platform server, and particularly illustrates the process related to OS error handling processing, according to one embodiment of the invention. At block 510, it is determined whether the OS was able to correct the error. For example, an error resulting from a head crash on a disk drive is a type of error that OS level error processing can readily resolve. If so, a failover unblanking procedure is initiated. It is determined whether there was a peer node (i.e. peer server blade) with an available NIC, which took over operations during the prior failover blanking procedure (block 512). If so, then the local node (i.e. local server blade) having the local NIC with the original MAC address is re-enabled (block 514) and resumes normal operations (block 520).

However, if there was not a peer node with an available NIC that took over operations during the prior failover blanking procedure, but the OS nonetheless corrected the error without a peer node taking over in the meantime, the local node (i.e. local server blade) is just re-enabled and resumes normal operations (block 520).

On the other hand, returning to block 510, if the OS error processing was unable to correct the error than the local node resets and during the next boot cycle executes a SAL call, which obtains state information from the OS (block 522). Again, it is determined whether there was a peer node (i.e. peer server blade) with an available NIC that took over operations during the prior failover blanking procedure (block 524). If so, then the local node (i.e. local server blade) having the local NIC with the original MAC address is re-enabled (block 530). Further, the SAL extracts the error log (block 532), an OS error log is built and an appropriate event log is generated with timestamps (block 534), and the local node (i.e. local server blade) resumes normal operations (block 536).

However, if it is determined that there was not a peer node (i.e. peer server blade) with an available NIC that took over operations during the prior failover blanking procedure (block 524), then SAL extracts the error log (block 532), an OS error log is built and an appropriate event log is generated with timestamps (block 534), and the local node (i.e. local server blade) merely resumes normal operations (block 536).

It should be noted that above-described seamless blade failover error recovery process advantageously allows the server platform to be continuously up and running while server blades are undergoing error recovery processes and are seamless taking over for one another. Further, it should be noted that in, one embodiment, each server blade may have at least one back-up NIC (see FIG. 2), such that the peer node (i.e. peer server blade) can utilize the back-up NIC to take over network traffic for the local node (i.e. local server blade) engaged in error containment, while continuing to process network traffic using its own original NIC.

The above-described seamless blade failover error recovery process, by utilizing the mutable/shareable nature of network identities, provides for platform-wide automatic self-healing enterprise system behavior. More particularly, by taking the error affected server blade (i.e. node, as previously discussed) off-line in firmware while passing its network ID to a NIC of a peer server blade (e.g. a backup NIC of a peer server blade), the latency of error containment may be drastically reduced or eliminated. In this way, host requests can continue to be processed. For stateless protocols like hypertext transfer protocol (HTTP) and a rack-configuration of front-end Web servers, the seamless blade failover error recovery process may provide continual responsiveness despite the failure of server blades. In addition, for load-balancing schemes like Round-Robin Domain Name System (RR-DNS), there may be little or no perturbation to platform system behavior.

Further, it should be appreciated by those of skill in the art, that although the above-described methods for seamless blade failover recovery have been described with respect to use in an exemplary server platform and as being implemented in firmware, that the seamless blade failover recovery process may be utilized in any type of blade-based computing system and may be implemented utilizing hardware, firmware, software, middleware, etc., or combinations thereof.

Accordingly, embodiments of the invention for a seamless blade failover error recovery process provide for constant, and “always-on”, network availability for nodes. Particularly, for front-end Web-servers with many peer identical front-end servers, the seamless blade failover error recovery process operates as a self-healing automatic computing algorithm. Moreover, the seamless blade failover error recovery process does not require the expensive and time-consuming porting of operating system present algorithms, drivers, and middleware.

While embodiments of the present invention and its various functional components have been described in particular embodiments, it should be appreciated that the embodiments of the present invention can be implemented in hardware, software, firmware, middleware or a combination thereof and utilized in systems, subsystems, components, or sub-components thereof. When implemented in software or firmware, the elements of the present invention are the instructions/code segments to perform the necessary tasks. The program or code segments can be stored in a machine readable medium (e.g. a processor readable medium or a computer program product), or transmitted by a computer data signal embodied in a carrier wave, or a signal modulated by a carrier, over a transmission medium or communication link. The machine-readable medium may include any medium that can store or transfer information in a form readable and executable by a machine (e.g. a processor, a computer, etc.). Examples of the machine-readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, bar codes, etc. The code segments may be downloaded via networks such as the Internet, Intranet, etc.

Further, while embodiments of the invention have been described with reference to illustrative embodiments, these descriptions are not intended to be construed in a limiting sense. Various modifications of the illustrative embodiments, as well as other embodiments of the invention, which are apparent to persons skilled in the art to which embodiments of the invention pertain, are deemed to lie within the spirit and scope of the invention.

1. A method comprising:
responsive to a platform error at a local node of a platform, performing error recovery at a processor abstraction layer (PAL);
if the platform error is not resolved at the PAL,
determining if there is a peer node with an available network interface card (NIC), and if there is a peer node with an available NIC,
sending a media access control (MAC) address of the local node to the peer node so that the peer node can handle operations for the local node, and
disabling the MAC address of the local node, and performing error recovery at a system abstraction layer (SAL);
if the platform error is resolved by the SAL,
enabling the local node with the MAC address of the local node, the local node to resume normal operation.

2. The method of claim 1, wherein if the SAL does not resolve the platform error, further comprising:
performing error recovery at the operating system (OS) level; and
if the platform error is resolved at the OS level,
enabling the local node with the MAC address of the local node, the local node to resume normal operation.

3. The method of claim 2, wherein if the platform error is not resolved at the OS level, further comprising:
resetting the local node; and
after re-booting the local node, obtaining state information from the operating system.

4. The method of claim 3, further comprising enabling the local node with the MAC address of the local node, the local node to resume normal operation.

5. The method of claim 4, further comprising:
extracting an error log; and
generating an event log.

6. The method of claim 1, wherein the local node is a first server blade and the peer node is a second server blade.

7. The method of claim 1, wherein the peer node utilizes a back-up NIC as the available NIC.

8. A machine-readable medium having stored thereon instructions, which when executed by a machine, cause the machine to perform the following operations comprising:
responsive to a platform error at a local node of a platform, performing error recovery at a processor abstraction layer (PAL);
if the platform error is not resolved at the PAL,
determining if there is a peer node with an available network interface card (NIC), and if there is a peer node with an available NIC,
sending a media access control (MAC) address of the local node to the peer node so that the peer node can handle operations for the local node, and
disabling the MAC address of the local node, and performing error recovery at a system abstraction layer (SAL);
if the platform error is resolved by the SAL,
enabling the local node with the MAC address of the local node, the local node to resume normal operation.

9. The machine-readable medium of claim 8, wherein if the SAL does not resolve the platform error, further comprising:
performing error recovery at the operating system (OS) level; and
if the platform error is resolved at the OS level,
enabling the local node with the MAC address of the local node, the local node to resume normal operation.

10. The machine-readable medium of claim 9, wherein if the platform error is not resolved at the OS level, further comprising:
resetting the local node; and
after re-booting the local node, obtaining state information from the operating system.

11. The machine-readable medium of claim 10, further comprising enabling the local node with the MAC address of the local node, the local node to resume normal operation.

12. The machine-readable medium of claim 11, further comprising:
extracting an error log; and
generating an event log.

13. The machine-readable medium of claim 8, wherein the local node is a first server blade and the peer node is a second server blade.

14. The machine-readable medium of claim 8, wherein the peer node utilizes a back-up NIC as the available NIC.

15. A server blade comprising:
a processor;
a memory coupled to the processor; and
a network interface card (NIC) coupled to the processor to provide for network communications to a peer server blade;
wherein responsive to a platform error at the server blade, error recovery is performed at a processor abstraction layer (PAL) and if the platform error is not resolved at the PAL, a media access control (MAC) address of the server blade is sent to the peer server blade so that the peer server blade can handle operations for the server blade, and the MAC address of the server blade is disabled.

16. The server blade of claim 15, wherein error recovery is further performed at a system abstraction layer (SAL) and if the platform error is resolved by the SAL, the server blade is enabled with the MAC address of the server blade, and the server blade resumes normal operation.

17. The server blade of claim 16, wherein if the SAL does not resolve the platform error, error recovery is performed at an operating system (OS) level, and if the platform error is resolved at the OS level, the server blade is enabled with the MAC address of the server blade, and the server blade resumes normal operation.

18. The server blade of claim 17, wherein if the platform error is not resolved at the OS level, the server blade is reset and after re-booting the server blade, state information is obtained from the operating system.

19. The server blade of claim 18, wherein the server blade is enabled with the MAC address of the server blade and the server blade resumes normal operation.

20. The server blade of claim 19, wherein an error log is extracted, an event log is generated, and the server blade resumes normal operation.

21. The server blade of claim 15, wherein the peer server blade utilizes a back-up NIC to handle operations for the server blade.

22. A server platform comprising:
a server blade rack;
a local server blade coupled to the server blade rack, the local server blade operating in conjunction with firmware; and
a peer server blade coupled to the server blade rack, the peer server blade operating in conjunction with firmware;
wherein responsive to a platform error at the local server blade, error recovery is performed at a processor abstraction layer (PAL) and if the platform error is not resolved at the PAL, a media access control (MAC) address of the local server blade is sent to the peer server blade so that the peer server blade can handle operations for the local server blade and the MAC address of the local server blade is disabled.

23. The server platform of claim 22, wherein error recovery is further performed at a system abstraction layer (SAL) and if the platform error is resolved by the SAL, the local server blade is enabled with the MAC address of the local server blade, the local server blade to resume normal operation.

24. The server platform of claim 23, wherein if the SAL does not resolve the platform error, error recovery is performed at an operating system (OS) level, and if the platform error is resolved at the OS level, the local server blade is enabled with the MAC address of the local server blade, and the local server blade resumes normal operation.

25. The server platform of claim 24, wherein if the platform error is not resolved at the OS level, the local server blade is reset and after re-booting the local server blade, state information is obtained from the operating system.

26. The server platform of claim 25, wherein the local server blade is enabled with the MAC address of the local server blade, and the local server blade resumes normal operation.

27. The server platform of claim 26, wherein an error log is extracted and an event log is generated.

28. The server platform of claim 22, wherein the peer server blade utilizes a back-up NIC to handle operations for the server blade.
